(19) United States
(12) Patent Application Publication
(10) Pub. No.: US 2018/0188351 A1
(43) Pub. Date: Jul. 5, 2018

(54) System and Methods for Identifying Positions of Physical Objects Based on Sounds

(71) Applicant: Wal-Mart Stores, Inc., Bentonville, AR (US)

(72) Inventors: Nicholaus Adam Jones, Fayetteville, AR (US); Matthew Allen Jones, Bentonville, AR (US); Aaron Vasgaard, Fayetteville, AR (US)

(21) Appl. No.: 15/860,096

(22) Filed: Jan. 2, 2018

Related U.S. Application Data
(60) Provisional application No. 62/442,207, filed on Jan. 4, 2017.

(51) Int. Cl. G01S 5/18

(52) U.S. Cl. CPC G01S 5/18

(57) ABSTRACT

Described in detail herein are methods and systems for identifying locations of objects based on detected sounds. In exemplary embodiments, a support structure can generate a sound, via a passive sound emitter, in response to a physical object being placed onto or removed from the support structure. An array of audio sensors disposed in a facility can detect sounds generated by the support structure and can encode the sounds into electrical signals. The audio sensors can output the electrical signals to a computing system. The computing system can identify the sounds encoded in the electrical signals which were detected by the audio sensors and can identify the location of the physical object on the support structure based on the identification of the sound.

### CROSS-REFERENCE TO RELATED PATENT APPLICATIONS

This application claims priority to U.S. Provisional Application No. 62/442,207 filed on Jan. 4, 2017, the content of which is hereby incorporated by reference in its entirety.

### BACKGROUND

Large facilities store physical objects in the facility. Objects are shipped to the facility prior to storage and are assigned locations for storage. Objects being shipped out of the facility are located prior to transit to an outside destination.

### SUMMARY

In one embodiment, a system for identifying positions of physical objects based on sounds includes a support structure configured to support a plurality of physical objects. The support structure includes one or more passive sound emitters configured to non-electrically generate a sound in response to at least one of the plurality of physical objects being placed onto or removed from the support structure. The system further includes an array of audio sensors disposed with respect to the support structure. The audio sensors are configured to detect the sound generated by the support structure and output electrical signals associated with the sound upon detection of the sound. The system further includes a computing system communicatively coupled to the audio sensors and a data storage device. The computing system is programmed to execute an analysis module to receive the electrical signals from at least one audio sensor in the array of audio sensors, identify the sound detected by the at least one audio sensor based on the received signals and determine the position of the at least one of the plurality of physical objects on the support structure based on the identified sound.

In one embodiment, a method for identifying positions of physical objects based on sounds includes generating, via a support structure configured to support a plurality of physical objects, a sound in response to at least one of the plurality of physical objects being placed onto or removed from the support structure. The support structure include one or more passive sound emitters configured to non-electrically generate the sound. The method further includes detecting, via an array of audio sensors disposed with respects to the support structure, the sound generated by the support structure. The method further includes outputting, via the audio sensors, electrical signals associated with the sound upon detection of the sound. The method further includes receiving, via a computing system communicatively coupled to the audio sensors and a data storage device, the electrical signals from at least one audio sensor in the array of audio sensors, identifying, via the computing system, the sound detected by the audio sensors based on the received signals and determining, via the computing system, a position of the at least one physical object on the support structure based on the identified sound.

### BRIEF DESCRIPTION OF DRAWINGS

To assist those of skill in the art in making and using the described system and methods for identifying positions of physical objects based on sounds, reference is made to the accompanying figures. The accompanying figures, which are incorporated in and constitute a part of this specification, illustrate one or more embodiments of the invention and, together with the description, help to explain the invention. In the figures:

FIG. 1 is a block diagram of audio sensors disposed in a facility in an exemplary embodiment;

FIG. 2 illustrates an exemplary object location identification system in accordance with an exemplary embodiment;

FIG. 3 illustrates an exemplary computing device in accordance with an exemplary embodiment; and

FIG. 4 is a flowchart illustrating an exemplary performance of an object location identification system according to an exemplary embodiment.

### DETAILED DESCRIPTION

Described in detail herein are methods and systems for identifying positions of physical objects based on detected sounds in a facility. In exemplary embodiments, a support structure can generate a sound, via a passive sound emitter, in response to a physical object being placed onto or removed from the support structure. An array of audio sensors disposed in a facility can detect sounds generated by the support structure. The array of audio sensors can encode the sounds into electrical signals and output the electrical signals to a computing system. The computing system can identify the sounds encoded in the electrical signals which were detected by the audio sensors and identify the location of the physical object on the support structure based on the identification of the sound.

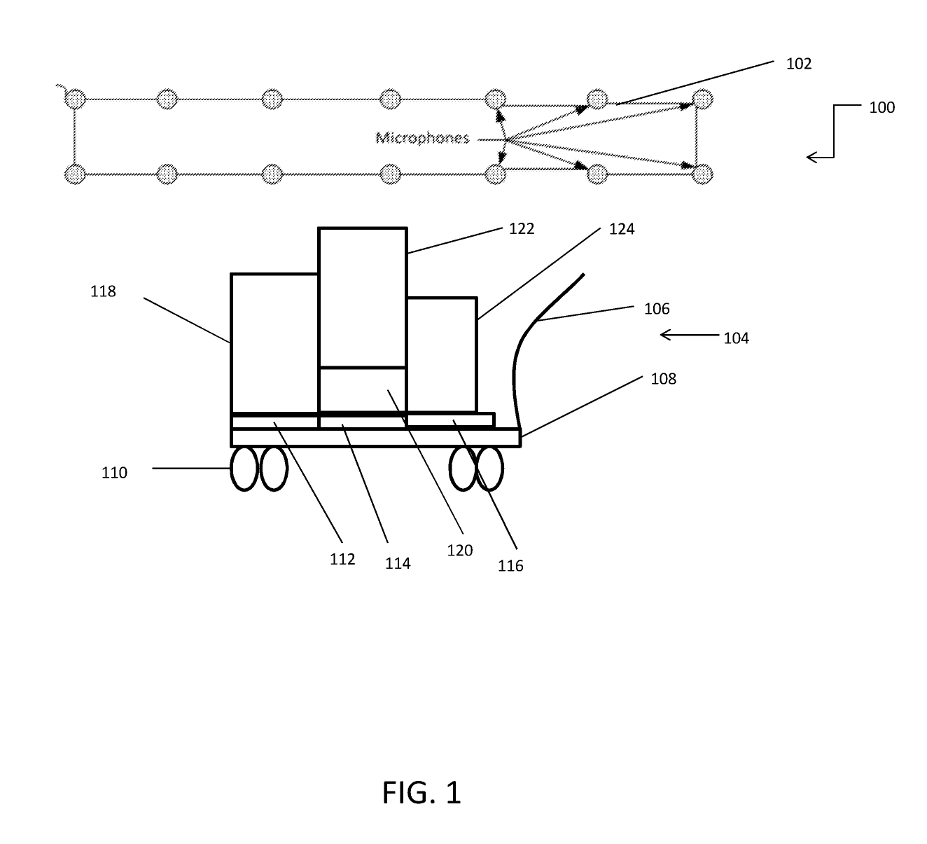

FIG. 1 is a block diagram of an array of audio sensors 102 such as, but not limited to, microphones disposed in a facility 100 according to an exemplary embodiment. The audio sensors 102 can be disposed at a predetermined distance of one another and can be disposed throughout the facility 100 and can be configured to detect sounds within a predetermined distance of the audio sensors 102. Each of the audio sensors 102 in the array can have a specified sensitivity and frequency response for detecting sounds. The audio sensors 102 can detect the intensity of the sounds, and the intensity value can be used to determine a distance between the audio sensors and a location where the sound was produced (e.g., a source or origin of the sound). For example, audio sensors closer to the source or origin of the sound can detect a sound with a greater intensity or amplitude than audio sensors that are farther away from the source or origin of the sound. A recorded location of the audio sensors can be used to estimate a location of the origin or source of the sound.

In one embodiment, the audio sensors 102 can be located in a room in a facility 100. Physical objects can be disposed in the room which are to be loaded onto a support structure, such as a cart 104. The cart 104 can include a handle 106, a base 108, wheels 110 and one or more pallets disposed on top of the base 108. The cart 104 can be divided into zones 112, 114 and 116 and the one or more pallets can be disposed in the zones. The pallet can include one or more passive non-electric sound emitting devices configured to generate a sound in response to receiving pressure and/or releasing pressure. In some embodiments, the sound emitting devices can be integrated with the cart 104. The sound emitting devices can generate a unique sound based on the amount of pressure or weight received and the zone 112, 114 and 116 in which the pressure is received or released. In some embodiments, the zones can be reduced in size such that the physical objects placed on the cart can cover more than one zone. Accordingly, when a physical object is placed on the cart and covers more than one zone, two different unique sounds can be emitted. In this manner, the size of the physical object can be determined based on the detection of multiple different sounds.

As an example, physical objects 118, 120, 122 and 124 can be loaded onto the cart 104. The physical objects 118, 120, 122 and 124 can all vary in size, dimensions and weight. The physical object 118 can be placed onto the pallet in zone 112, the physical objects 120-122 can be placed onto the pallet in zone 114 and the physical object 124 can be placed onto the pallet in zone 116. The sound emitting devices can generate a unique sound in response to each of the physical objects being loaded onto the pallet. For example, the sound emitting devices can generate a sound based on the size, weight and zone of each of the physical objects 118, 120, 122 and 124. The array of audio sensors 102 can detect each sound generated, in response to each of the physical objects 118, 120, 122 and 124 being loaded onto the cart 104. Furthermore, the sound emitting devices can be configured to make a unique sound as each physical object 118, 120, 122 and 124 are removed from the cart 104. Each of the audio sensors 102 can detect intensities, amplitudes, and/or frequency for each sound generated. Because the audio sensors 102 are geographically distributed within the facility 100, audio sensors that are closer to the cart 104 can more easily detect the sounds as compared to audio sensors that are farther away from the cart. As a result, the audio sensors 102 can detect the same sounds, but with different intensities or amplitudes based on a distance of each of the audio sensors to the cart 104. The audio sensors 102 can also detect a frequency of each sound detected. The audio sensors 102 can encode the detected sounds (e.g., intensities or amplitudes and frequencies of the sound) in time varying electrical signals. The time varying electrical signals can be output from the audio sensors 102 and transmitted to a computing system for processing.

Although the support structure in FIG. 1 is described as being a cart, it should be appreciated that the support structure may also take other forms without departing from the scope of the present invention. For example, in one embodiment, the support structure that includes one or more passive sound emitting devices may take the form of a pallet. In other embodiments, the support structure may be another type of structure equipped with one or more passive sound emitters and configured as described herein.

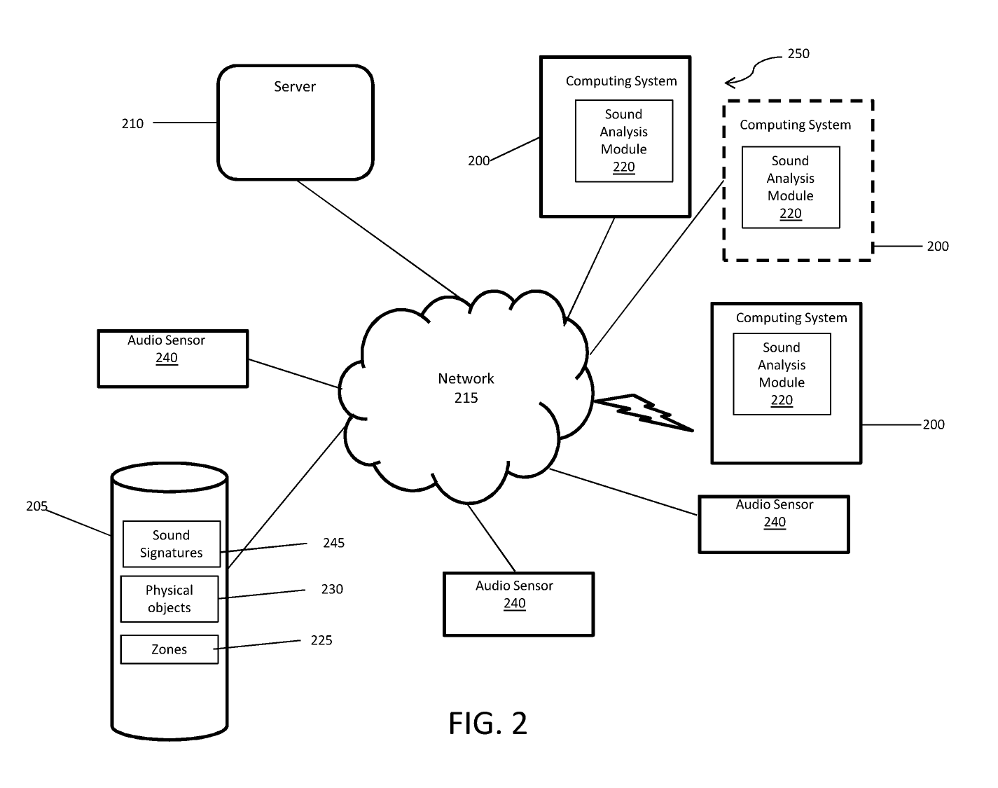

FIG. 2 illustrates an exemplary object location identification system 250 in accordance with exemplary embodiments. The object location identification system 250 can include one or more databases 205, one or more servers 210, one or more computing systems 200, and the audio sensors 240. In exemplary embodiments, the computing system 200 can be in communication with the databases 205, the server(s) 210, and the audio sensors 240, via a communications network 215. The computing system 200 can implement at least one instance of the sound analysis module 220.

In an example embodiment, one or more portions of the communications network 215 can be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The computing system 200 includes one or more computers or processors configured to communicate with the databases 205 and kiosks 245 via the network 215. The computing system 200 hosts one or more applications configured to interact with one or more components of the object location identification system 250. The databases 205 may store information/data, as described herein. For example, the databases 205 can include a zones database 225, physical objects database 230 and sound signatures database 245. The zones database 225 can store information associated with each zone of a support structure. The physical objects database 230 can store information associated with physical objects. The sound signature database 245 can store sound signatures based on amplitudes and frequencies for of known sounds. The databases 205 and server 210 can be located at one or more geographically distributed locations from each other or from the computing system 200. Alternatively, the databases 205 can be included within server 210 or computing system 200.

In exemplary embodiments, physical objects can be loaded onto and/or removed from a support structure such as a pallet and/or cart. The support structure can be divided into different zones. The support structure can emit a unique sound, via a passive sound emitting device, in response to the physical object being loaded onto and/or removed from the support structure based on the particular zone of the support structure on which the physical object is loaded, or removed from, and the size and weight of the physical objects. The audio sensors 240 can detect the sounds (including detected intensities, amplitudes, and frequencies of the sounds) and encode the sounds into electrical signals for transmittal to the computing system 200.

In one embodiment, the computing system 200 can receive multiple time varying electrical signals from the audio sensors 240, where each of the time varying electrical signals are encoded with data associated with sounds (e.g., detected intensities, amplitudes, and frequencies of the sounds). The computing system 200 can execute the sound analysis module 220 in response to receiving the time varying electrical signals. The sound analysis module 220 can decode the time varying electrical signals and extract the intensity, amplitude, and frequency of the detected sound. The sound analysis module 220 can determine the distance of the detecting audio sensors 102 to the location where the sound occurred based on the intensity or amplitude of the sound detected by each audio sensor. The sound analysis module 220 can also estimate the location of each sound based on the determined distance. The sound analysis module 220 can further query the sound signature database 245 using the extracted amplitude and frequency to retrieve the sound signature of the sound. The sound analysis module 220 can identify the sounds encoded in each of the time varying electrical signals based of the retrieved sound signature(s) and the distance between the audio sensor and the origins or sources of the sounds. In an embodiment, the sound analysis module 220 can also determine the size of the physical object that is loaded onto or removed from the support structure based on the intensity of the detected sound and stored signatures. The sound analysis module 220 can query the zones database 225 using the identification of the sound to determine which zone(s) of the support structure the physical object was loaded onto or removed from. In one embodiment, the sound analysis module 220 can query the physical objects database 230 to determine which physical objects are designated to be loaded onto or off of the support structure. The sound analysis module 220 can determine the identification of the physical object loaded onto or off of the support structure based on the determined size and the determined physical objects designated to be loaded onto or off of the support structure. Furthermore, the sound analysis module 220 can determine the location of the physical object on the support structure based on the identification of the zone on which the physical object is located and the intensity of the sound. In some embodiments, the sound analysis module 220 can determine the location of the physical object on the support structure in 3D space. In some embodiments, in the event multiple audio sensors 240 detect the same unique sounds, the sound analysis engine 220 can use trilateration and/or triangulation to determine the location of the physical object on the support structure in 3D space.

For example, a first physical object can be loaded onto the support structure. The first physical object can be located in a first zone of the support structure. The support structure can generate a first sound in response to the first physical object being loaded onto the support structure in the first zone. A second physical object can be loaded on top of first physical object located in a first zone of the support structure. The support structure can generate a second sound in response to the second physical object being loaded on top of the first physical object. Subsequently, a third physical object can be loaded onto the support structure in a second zone. The support structure can generate a sound in response to the third physical object being loaded onto the support structure in the second zone. The audio sensors 240 can detect the first, second and third sounds and encode the sounds (including the intensities, frequencies and amplitudes) into time-varying electrical signals and transmit the electrical signals to the computing system 200.

Continuing with the example, computing system 200 can execute the sound analysis module 220 in response to receiving the time electrical signals. The sound analysis module 220 can decode the intensities, frequencies and amplitudes of the first, second and third sounds from the time-varying electrical signals. The sound analysis module 220 can determine the size and weight of each physical object based on the intensity of the sound generated in response to being loaded onto the support structure. The sound analysis module 220 can query the physical objects database 230 to determine which physical objects are designated to be loaded onto the support structure. The sound analysis module 220 can query the sound signature database 245 using the frequency and amplitudes of the first, second and third sounds to identify each of the sounds. The sound analysis module 220 can query the zones database 225 using the identified sounds to determine which zone is correlated to each of the sounds. The sound analysis module 220 can determine the sound generated in response to loading the first and second physical object onto the support structure are correlated with the first zone and the sound generated in response to the third physical object being loaded onto the support structure is correlated to the second zone. Accordingly, the sound analysis module 220 can determine the first and second physical object are disposed in the first zone and the third physical object is disposed in the third zone on the support structure. Furthermore, based on the determined size and weight of each of the physical objects, the sound analysis module 220 can determine the location of the physical objects in a three-dimensional (3D) space. Accordingly, the sound analysis module 220 can determine the second physical object is located on top of the first physical object and the third physical object is located directly on the support structure. The sound analysis module 220 can transmit an alert in response to a determination that the position of the first, second or third physical object on the support structure is incorrect.

In one embodiment, the computing system 200 can receive the time-varying electrical signals in the order in which the sounds were generated. Accordingly, the sound analysis module 220 can determine the order in which the physical objects are loaded onto the support structure based on the order in which the computing system 200 receives the time-varying electrical signals. The sound analysis module 220 can transmit an alert in response to determining the physical objects were loaded onto the support structure in an incorrect order.

In some embodiments, the support structure can generate a first, second and third sound as a first, second and third physical objects are off loaded from the support structure. The audio sensors 240 can detect the first, second and third sounds and encode the sounds (including the intensities, frequencies and amplitudes) into time-varying electrical signals and transmit the electrical signals to the computing system 200. The computing system 200 can execute the sound analysis module 220 in response to receiving the electrical signals. The sound analysis module 220 can decode the sound data (including the intensities, frequencies and amplitudes) from the electrical signals and can determine the size and weight of the physical objects being removed from the support structure based on the intensity of the sound generated by the physical objects being removed. The sound analysis module 220 can query the physical objects database 230 to determine which physical objects are designated to be offloaded from the support structure. The sound analysis module 220 can identify each physical object offloaded. Furthermore, the sound analysis module 220 can determine the location at which each physical object was removed based on the location of the audio sensors 240 which detected the sounds. The sound analysis module 220 can transmit an alert in response to determining the physical object was offloaded in an incorrect location.

In some embodiments, the sound analysis module 220 can receive and determine that a same sound was detected by multiple audio sensors, encoded in various electrical signals, with varying intensities. The sound analysis module 220 can determine that a first electrical signal is encoded with the highest intensity as compared to the remaining electrical signals. The sound analysis 220 can query the sound signature database 245 using the intensity, amplitude and frequency of the first electrical signal to retrieve the identification of the sound encoded in the first electrical signal and discard the remaining electrical signals with lower intensities than the first electrical signal.

As mentioned above, in some embodiments, the zones on the support structure can be reduced in size such that the physical object placed on the cart can cover more than one zone. A unique sound can be generated for each zone which the physical object covers. The audio sensors 240 can detect each unique sound, encode the sounds into time-varying electrical signals and transmit the time-varying electrical signals to the computing system. The sound analysis engine 220 can decode the electrical signals, query the zones database 225 and sound signature database 245 and determine the size of the physical objects based on the amount of zones covered by the physical object.

As a non-limiting example, the object location identification system 250 can be implemented in a retail store or warehouse. An array of audio sensors 240 can be disposed in the facility. In one example, the audio sensors 240 can be disposed in a stock room near a loading area of the facility. A delivery truck can unload products in the loading area. The loading area can include a support structure such as a pallet or a cart. The support structure can include one or more passive sound emitting devices, configured to emit a unique sound in response to products being loaded onto, or removed from, the support structure, based on size, weight and/or location of the products. For example, a first product can be loaded onto the support structure from the truck in a first zone of the support structure and the one or more passive sound emitting devices can generate a first sound. A second product can be loaded onto the support structure from the truck in a second zone of the support structure and the one or more passive sound emitting devices can generate a second sound. A third product can be loaded onto the support structure from the truck on top of the second product in the second zone of the support structure and the one or more passive sound emitting devices can generate a third sound. The first, second and third sounds can be different from one another. The audio sensors 240 can detect the first, second and third sounds in that respective order. The audio sensors 240 can encode each detected sound (including the amplitude, frequency and intensities) into time-varying electrical signals. The audio sensors can transmit a first, second and third electrical signals to the computing system 200 for analysis as described herein.

In another example, the audio sensors 240 can be disposed throughout the retail store. Products can be loaded onto a support structure such as a cart or pallet to be carried around the retail store so that the products can be stocked on storage units or shelves in the retail store. The support structure can generate a first, second and third sound as the first, second and third products are removed from the support structure for stocking in the storage units and/or shelves. The audio sensors 240 can detect the first, second and third sounds and encode the sounds (including the intensities, frequencies and amplitudes) into time-varying electrical signals and transmit the electrical signals to the computing system 200. The computing system 200 can execute the sound analysis module 220 in response to receiving the electrical signals. The sound analysis module 220 can decode the sounds (including the intensities, frequencies and amplitudes) from the electrical signals. The sound analysis module 220 can determine the size and weight of the products being offloaded from the support structure based on the intensity of the sound generated in response to the products being offloaded. The sound analysis module 220 can query the physical objects database 230 to determine which products are designated to be offloaded from the support structure. The sound analysis module 220 can identify each product offloaded. Furthermore, the sound analysis module 220 can determine the location from which each product was removed based on the location of the audio sensors 240 that detected the sounds. The sound analysis module 220 can transmit an alert in response to determining the product was offloaded and/or stocked in an incorrect location.

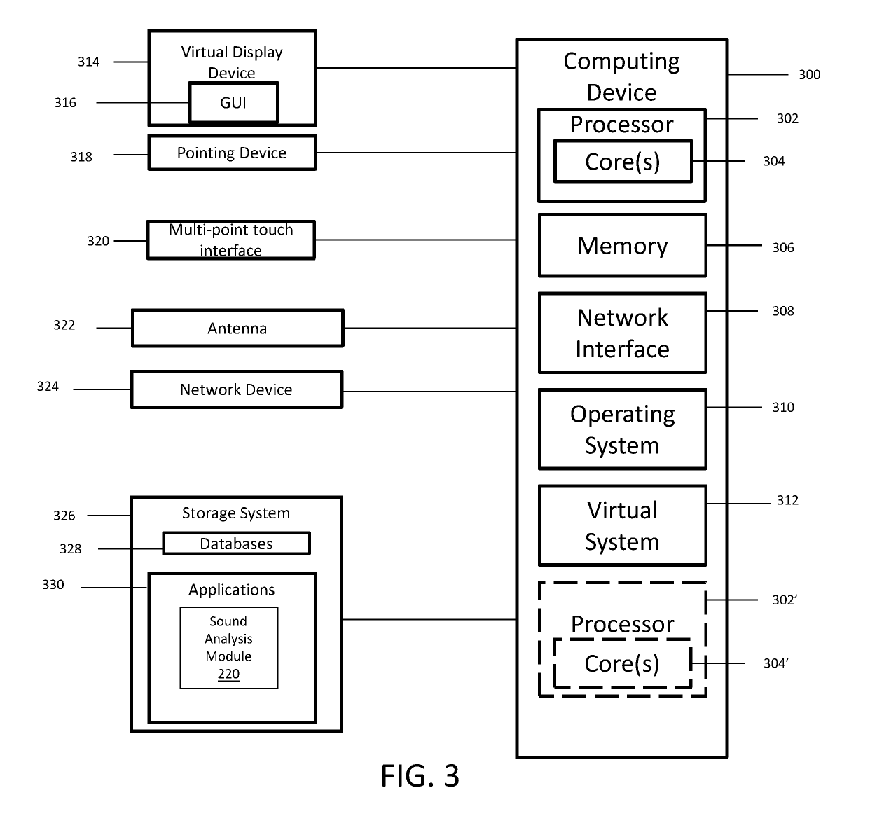

FIG. 3 is a block diagram of an exemplary computing device 300 for suitable for use in an exemplary embodiment. Computing device 300 can execute sound analysis module as described herein. The computing device 300 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 306 included in the computing device 300 may store computer-readable and computer-executable instructions or software (e.g., applications 330 or other instructions such as the sound analysis module 220) for implementing exemplary operations of the computing device 300. The computing device 300 also includes configurable and/or programmable processor 302 and associated core(s) 304, and optionally, one or more additional configurable and/or programmable processor(s) 302′ and associated core(s) 304′ (for example, in the case of computer systems having multiple processors/cores), for executing computer-readable and computer-executable instructions or software stored in the memory 306 and other programs for implementing exemplary embodiments of the present disclosure. Processor 302 and processor(s) 302′ may each be a single core processor or multiple core (304 and 304′) processor. Either or both of processor 302 and processor(s) 302′ may be configured to execute one or more of the instructions described in connection with computing device 300.

Virtualization may be employed in the computing device 300 so that infrastructure and resources in the computing device 300 may be shared dynamically. A virtual machine 312 may be provided to handle a process running on multiple processors so that the process appears to be using only one computing resource rather than multiple computing resources. Multiple virtual machines may also be used with one processor.

Memory 306 may include a computer system memory or random access memory, such as DRAM, SRAM, EDO RAM, and the like. Memory 306 may include other types of memory as well, or combinations thereof.

A user may interact with the computing device 300 through a visual display device 314, such as a computer monitor, which may display one or more graphical user interfaces 316, multi touch interface 320 and a pointing device 318.

The computing device 300 may also include one or more storage devices 326, such as a hard-drive, CD-ROM, or other computer readable media, for storing data and computer-readable instructions and/or software that implement exemplary embodiments of the present disclosure (e.g., applications). For example, exemplary storage device 326 can include one or more databases 328 for storing information regarding the sounds produced by actions taking place in a facility, sound signatures, information associated with zones of a support structure and information associated with physical objects. The databases 328 may be updated manually or automatically at any suitable time to add, delete, and/or update one or more data items in the databases.

The computing device 300 can include a network interface 308 configured to interface via one or more network devices 324 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing system can include one or more antennas 322 to facilitate wireless communication (e.g., via the network interface) between the computing device 300 and a network and/or between the computing device 300 and other computing devices. The network interface 308 may include a built-in network adapter, network interface card, PCMCIA network card, card bus network adapter, wireless network adapter, USB network adapter, modem or any other device suitable for interfacing the computing device 300 to any type of network capable of communication and performing the operations described herein.

The computing device 300 may run operating system 310, such as versions of the Microsoft® Windows® operating systems, different releases of the Unix and Linux operating systems, versions of the MacOS® for Macintosh computers, embedded operating systems, real-time operating systems, open source operating systems, proprietary operating systems, or any other operating system capable of running on the computing device 300 and performing the operations described herein. In exemplary embodiments, the operating system 310 may be run in native mode or emulated mode. In an exemplary embodiment, the operating system 310 may be run on one or more cloud machine instances.

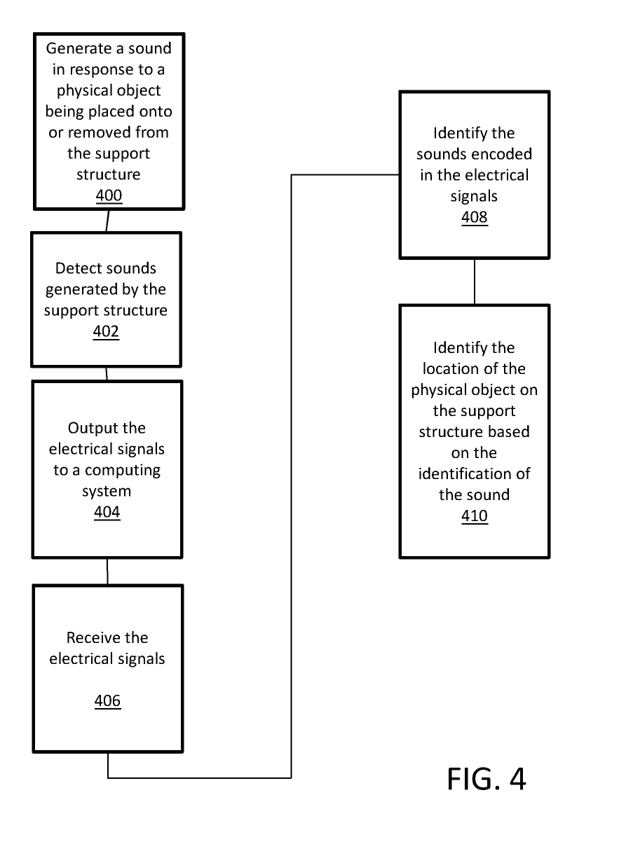

FIG. 4 is a flowchart illustrating a process implemented by an object location identification system according to exemplary embodiments of the present disclosure. In operation 400, a support structure (e.g. cart 104 as shown in FIG. 1 or pallet) configured to support physical objects can generate a sound in response to a physical object being placed onto or removed from the support structure. The support structure can generate the sound using a passive sound emitter. In operation 402, an array of audio sensors (e.g. audio sensors 102, 240 shown in FIGS. 1-2) disposed in a facility (e.g. facility 100 shown in FIG. 1) can detect sounds generated by the support structure. The array of audio sensors can encode the sounds into electrical signals. In operation 404, the audio sensors can output the electrical signals to a computing system (e.g. computing system 200 as shown in FIG. 2). In operation 406, the computing system can receive the electrical signals encoded with sound data. The computing system can decode the electrical signals. In operation 408, the computing system can identify the sounds based on the data encoded in the electrical signals. In operation 410, the computing system can identify the location of the physical object on the support structure based on the identification of the sound using the sound analysis module as described herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other aspects, functions and advantages are also within the scope of the present disclosure.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

We claim:

1. A system for identifying positions of physical objects based on sounds, the system comprising:
a support structure configured to support a plurality of physical objects, the support structure including one or more passive sound emitters configured to non-electrically generate a sound in response to at least one of the plurality of physical objects being placed onto or removed from the support structure;
an array of audio sensors disposed with respect to the support structure, the audio sensors configured to detect the sound generated by the support structure and output electrical signals associated with the sound upon detection of the sound; and
a computing system communicatively coupled to the audio sensors and a data storage device, the computing system programmed to execute an analysis module to:
receive the electrical signals from at least one audio sensor in the array of audio sensors;
identify the sound detected by the at least one audio sensor based on the received signals; and
determine the position of the at least one of the plurality of physical objects on the support structure based on the identified sound.

2. The system of claim 1 wherein the support structure is a pallet that includes a plurality of sections.

3. The system of claim 1 wherein the support structure is a cart.

4. The system of claim 1, wherein the audio sensors are further configured to detect an intensity of the sound and encode the intensity of the sound in the electrical signals.

5. The system of claim 4, wherein the computing system is further programmed to triangulate the position of the at least one physical object in 3-dimensional space based on the intensity of the sound.

6. The system of claim 1, wherein the one or more passive sound emitters are further configured to generate a different sound based on a section of the support structure on which the physical object is placed or removed.

7. The system of claim 6, wherein the audio sensors are further configured to detect amplitude and frequency of different sounds and encode the amplitude and the frequency in time varying electrical signals.

8. The system of claim 7, wherein the computing system is further configured to:
determine a sound signature based on the amplitude and the frequency encoded in each electrical signal; and
query the data storage device using the sound signature to identify a section of the support structure with which the sound signature corresponds.

9. The system of claim 1, wherein the computing system is further configured to determine that the at least one physical object is an incorrect position on the support structure.

10. The system of claim 9, wherein the computing system transmits an alert in response to determining that the at least one physical object is in the incorrect position.

11. The system of claim 1, wherein the one or more passive sound emitters are further configured to generate a different type of sound based on whether the at least one physical object is being placed onto or removed from the support structure.

12. A method for identifying positions of physical objects based on sounds, the method comprising:
generating, via a support structure configured to support a plurality of physical objects, a sound in response to at least one of the plurality of physical objects being placed onto or removed from the support structure, the support structure including one or more passive sound emitters configured to non-electrically generate the sound;
detecting, via an array of audio sensors disposed with respects to the support structure, the sound generated by the support structure;
outputting, via the audio sensors, electrical signals associated with the sound upon detection of the sound;
receiving, via a computing system communicatively coupled to the audio sensors and a data storage device, the electrical signals from at least one audio sensor in the array of audio sensors;
identifying, via the computing system, the sound detected by the audio sensors based on the received signals; and
determining, via the computing system, a position of the at least one physical object on the support structure based on the identified sound.

13. The method of claim 12 wherein the support structure is a pallet that includes a plurality of sections.

14. The method of claim 12, further comprising:
detecting, via the audio sensors, an intensity of the sound; and
encoding, via the audio sensor, the intensity of the sound in the electrical signals.

15. The method of claim 14, further comprising:
triangulating, via the computing system, the at least one physical object's position in 3-dimensional space based on the intensity of the sound.

16. The method of claim 15, further comprising:
generating, via the one or more passive sound emitters, a different sound based on a section of the support structure on which the physical object is placed or removed.

17. The method of claim 16, further comprising:
detecting, via the audio sensors, an amplitude and frequency of each different sound and encoding, via the audio sensors, the amplitude and the frequency in the electrical signals.

18. The method of claim 17, further comprising:
determining, via the computing system, a sound signature based on the amplitude and the frequency encoded in each electrical signal; and
querying, via the computing system, the database using the sound signature to identify a section of the support structure with which the sound signature corresponds.

19. The method of claim 12, further comprising:
determining, via the computing system, that the at least one physical object is an incorrect position on the support structure.

20. The method of claim 19, further comprising:
transmitting, via the computing system, an alert in response to determining that the at least one physical object is in the incorrect position.

21. The method of claim 1, wherein the one or more passive sound emitters are further configured to generate a different type of sound based on whether the at least one physical object is being placed onto or removed from the support structure.
